(19) United States
(12) Patent Application Publication
(10) Pub. No.: US 2026/0128982 A1
(43) Pub. Date: May 7, 2026

(54) SYSTEMS AND METHODS FOR MITIGATING NETWORK ERRORS CAUSED BY DUPLICATE IP ADDRESSES

(71) Applicant: CenturyLink Intellectual Property LLC, Denver, CO (US)

(72) Inventors: John R.B. Woodworth, Amissville, VA (US); Dean Ballew, Sterling, VA (US)

(73) Assignee: CenturyLink Intellectual Property LLC, Denver, CO (US)

(21) Appl. No.: 19/380,370

(22) Filed: Nov. 5, 2025

Related U.S. Application Data
(60) Provisional application No. 63/716,381, filed on Nov. 5, 2024.

(51) Int. Cl. H04L 45/28; H04L 45/02

(52) U.S. Cl. CPC H04L 45/28; H04L 45/02

(57) ABSTRACT

Duplicate IP addresses within a network can lead to misdelivered packets or network outages. To mitigate routing errors, routers may enter an error mode when a duplicate IP address is detected, such as when a router advertising a route to a particular IP address receives an advertisement from another router for the same IP address. While operating in the error mode, the router updates packets to/from the duplicate IP address with a port number that satisfies a port criterion. When the router receives a packet addressed to the duplicate IP address, the router determines whether the destination port number satisfies the criterion. If the port number satisfies the criterion, the router routes the packet to a first host associated with the IP address. Otherwise, the router forwards the packet to the second router for delivery to a second host associated with the (same) IP address.

### CROSS-REFERENCE TO RELATED APPLICATIONS

This application claims the benefit of U.S. Provisional Application No. 63/716,381 filed November 5, 2024, entitled “Systems and Methods for Mitigating Network Errors Caused by Duplicate IP Addresses,” which is incorporated herein by reference in its entirety.

### BACKGROUND

Networks such as the Internet typically route packets to a host device based on an Internet protocol (IP) address associated with the host device. In general, each host device connected to the network has a unique IP address that is used for routing network traffic to/from that host. In some cases, however, the same IP address may be inadvertently assigned to multiple (different) hosts. When this happens, the network routers may deliver a packet to the wrong host or experience other network errors such as network outages.

It is with respect to this general technical environment that aspects of the present disclosure are related.

### SUMMARY

The present application describes a method including: advertising, to a network, a first route to a first internet protocol (IP) address, where the first route ends at a first host device; receiving, from a second router of the network, an advertisement for a second route to the first IP address; determining that the advertisement for the second route to the first IP address is indicative of an error condition; in response to determining that the advertisement for the second route to the first IP address is indicative of an error condition, entering an error mode, where entering the error mode includes identifying a first port criterion; while operating in the error mode, receiving a first packet from the first host device, where the first packet includes the first IP address as a first source IP address, a first port number as a first source port number, and a second IP address as a first destination IP address; determining that the first source port number fails to satisfy the first port criterion; in response to determining that the first source port number fails to satisfy the first port criterion, updating the first packet to generate an updated first packet by replacing the first source port number with a second source port number that satisfies the first port criterion to generate an updated first packet; and forwarding the updated first packet, including the first IP address and the second source port number, to a third host device associated with the second IP address.

In some examples, the method further includes: after forwarding the updated first packet to the third host device, receiving a second packet in response to the first packet, the second packet including the first IP address as a destination IP address, the second source port number as a first destination port number, and the second IP address as a second source IP address; determining that the first destination port number satisfies the first port criterion; and in response to determining that the first destination port number satisfies the first port criterion: replacing the first destination port number with the first source port number in the second packet to generate an updated second packet, and forwarding the updated second packet to the first host device.

In some examples, the method further includes: in response to receiving the advertisement of the second route to the first IP address from the second router, sending a notification to the second router indicating an error condition.

In some examples, the notification includes an indication of port criteria including the first port criterion.

In some examples, the method further includes: while operating in the error mode, receiving a third packet that includes the first IP address as a third source IP address, a third port number as a third source port number, and the second IP address as a second destination IP address; determining that the third source port number satisfies the first port criterion; in response to determining that the third source port number satisfies the first port criterion, forwarding the third packet, including the first IP address and the third source port number, to the third host device without updating the third source port number; receiving a fourth packet in response to the third packet, the fourth packet including the first IP address as a third destination IP address, the third port number as a third destination port number, and the second IP address as a third source IP address; determining that the third destination port number satisfies the first port criterion; and in response to determining third destination port number satisfies the first port criterion, forwarding the third packet to the first host device.

In some examples, the method further includes: while operating in the error mode, receiving a fifth packet from a third host device, the fifth packet including the first IP address as a fourth destination IP address, a third IP address as a fourth source IP address, and a fourth port number as a fourth destination port number, determining that the first IP address is a duplicated IP address and the fifth packet is not a response packet; and in response to determining that the first IP address is the duplicated IP address and the fifth packet is not the response packet, forwarding the fifth packet to the first host device and to the second router.

The present application further describes a router including: at least one processor; and memory, storing instructions that, when executed individually or collectively by the at least one processor, cause the router to perform a method, the method including: advertising, to a network, a first route to a first internet protocol (IP) address, where the first route ends at a first host device; receiving, from a second router of the network, an advertisement for a second route to the first IP address; determining that the advertisement for the second route to the first IP address is indicative of an error condition; in response to determining that the advertisement for the second route to the first IP address is indicative of an error condition, entering an error mode, where entering the error mode includes identifying a first port criterion; while operating in the error mode, receiving a first packet from the first host device, where the first packet includes the first IP address as a first source IP address, a first port number as a first source port number, and a second IP address as a first destination IP address; determining that the first source port number fails to satisfy the first port criterion; in response to determining that the first source port number fails to satisfy the first port criterion, updating the first packet to generate an updated first packet by replacing the first source port number with a second source port number that satisfies the first port criterion; and forwarding the updated first packet, including the first IP address and the second source port number, to a third host device associated with the second IP address.

In some examples, the method further includes: after forwarding the updated first packet to the third host device, receiving a second packet in response to the first packet, the second packet including the first IP address as a destination IP address, the second source port number as a first destination port number, and the second IP address as a second source IP address; determining that the first destination port number satisfies the first port criterion; and in response to determining that the first destination port number satisfies the first port criterion: replacing the first destination port number with the first source port number in the second packet to generate an updated second packet, and forwarding the updated second packet to the first host device.

In some examples, the method further includes: in response to receiving the advertisement of the second route to the first IP address from the second router, sending a notification to the second router indicating an error condition.

In some examples, the notification includes an indication of port criteria including the first port criterion.

In some examples, the method further includes: while operating in the error mode, receiving a third packet that includes the first IP address as a third source IP address, the second IP address as a third destination IP address, and a third port number as a third source port number; determining that the third source port number satisfies the first port criterion; in response to determining that the third source port number satisfies the first port criterion, forwarding the third packet, including the first IP address and the third source port number, to the third host device without updating the third source port number; receiving a fourth packet in response to the third packet, the fourth packet including the first IP address as a third destination IP address, the third port number as a third destination port number, and the second IP address as a third source IP address; determining that the third destination port number satisfies the first port criterion; and in response to determining third destination port number satisfies the first port criterion, forwarding the third packet to the first host device.

In some examples, the method further includes: while operating in the error mode, receiving a fifth packet from a third host device, the fifth packet including the first IP address as a fourth destination IP address, a third IP address as a fourth source IP address, and a fifth port number as a fourth destination port number; determining that the first IP address is a duplicated IP address and the fifth packet is not a response packet; in response to determining that the first IP address is the duplicated IP address and the fifth packet is not the response packet, forwarding the fifth packet to the first host device and to the second router.

The present application further describes routing system including: a first router connected to a network and configured to advertise, to the network, a first set of one or more routes to a first set of one or more Internet protocol addresses (IP addresses); a second router connected to the network and configured to advertise, to the network, a second set of one or more routes to a second set of one or more Internet protocol addresses (IP addresses); where the first router is configured to: enter an error mode in response to receiving an advertisement from the second router advertising a route to a first IP address that is included in the first set of one or more IP addresses, where entering the error mode includes identifying a first port criterion; while operating in the error mode: receive a first packet from a first host device associated with the first IP address, where the first packet includes the first IP address as a first source IP address, a first port number as a first source port number, and a second IP address as a first destination IP address; determine that the first source port number fails to satisfy the first port criterion; based on determining that the first source port number fails to satisfy the first port criterion, update the first packet to generate an updated first packet by replacing the first source port number with a second source port number that satisfies the first port criterion; and forward the updated first packet, including the first IP address and the second source port number, to a third host device associated with the second IP address.

In some examples, the second router is configured to: enter the error mode in response to receiving an advertisement from the first router advertising a route to the first IP address, where entering the error mode includes identifying a second port criterion different from the first port criterion; while operating in the error mode: receive a second packet from a second host device associated with the first IP address, where the second packet includes the first IP address as a first source IP address, a third port number as a third source port number, and a third IP address as a second destination IP address, where the third IP address is associated with a third host device; determine that the second source port number fails to satisfy the second port criterion; based on determining that the second source port number fails to satisfy the second port criterion, update the second packet to replace the third source port number with a fourth source port number that satisfies the second port criterion; and forward the updated first packet, including the first IP address and the third source port number, to the third host device.

In some examples, the first router is configured to send an indication of the first port criterion to the second router.

In some examples, the second router is configured to identify a second port criterion based on the first port criterion.

In some examples, the first router is configured to identify the first port criterion based on receiving a second port criterion from the second router.

In some examples, the first router is configured to identify the first port criterion based on a loopback IP address of the first router.

In some examples, the first router is further configured to: receive a second packet from the second router, the second packet including the first IP address as a second destination IP address and a third port number as a third destination port number; determine that the third port number satisfies the first port criterion; and based on determining that the third port number satisfies the first port criterion, forward the second packet to the first host device.

In some examples, the first source port number satisfies the first port criterion when the first source port number is an odd number, and the first source port number fails to satisfy the first port criterion when the first source port number is an even number.

### BRIEF DESCRIPTION OF THE DRAWINGS

These and other features and advantages of the present disclosure will be appreciated and understood with reference to the specification, claims, and appended drawings wherein:

FIG. 1 is a block diagram of a portion of a network system, according to an embodiment of the present disclosure;

FIG. 2 is a swim lane diagram of a method, according to an embodiment of the present disclosure;

FIG. 3 is a swim lane diagram of a method, according to an embodiment of the present disclosure;

FIG. 4 is a swim lane diagram of a method, according to an embodiment of the present disclosure;

FIGS. 5A-5B depict a flow chart of a method, according to an embodiment of the present disclosure; and

FIG. 6 is a block diagram of a computing device, according to an embodiment of the present disclosure.

### DETAILED DESCRIPTION

Internet protocol (IP) addresses are used to uniquely identify hosts that are connected to a network, such as computers, printers, routers, servers, or other types of devices. An IP address may be a 32-bit or 128-bit number, for example. In normal operation, each host has its own unique IP address that can be used by routers within the network to address packets to the intended host recipient. For example, a first host with a first IP address may send a packet to a second host with a second IP address. The second host may then reply to the first host by sending a packet to the first host using the first IP address. In some cases, however, two hosts may inadvertently be assigned to the same IP address, which may result in various network failures. For example, duplicate IP addresses may cause packet delivery errors in which a packet addressed to the duplicate IP address is delivered to the wrong host. In other cases, duplicate IP addresses can cause network outages in which packets address to the duplicate IP address are not delivered at all.

As described herein, problems caused by duplicated IP addresses can be mitigated using disambiguation techniques implemented at one or more routers that are each configured to route network traffic to a host that has a duplicated IP address. In practice, such techniques will typically be performed by two routers, since typically only two hosts will have duplicate IP addresses. It is possible, however, that more than two hosts will inadvertently be assigned to the same IP address and hence more than two routers may use the disambiguation techniques described herein. For simplicity, however, examples herein refer to the most common case of two affected hosts and two correspondingly affected routers. In addition, references to an IP address should be understood to potentially include groups of IP addresses such as a /24 subnet.

In some examples, upon detecting the existence of a duplicate IP address, each router that serves one of the affected hosts enters an error mode. In this case, each router that is advertising a route to a host with the duplicate IP address identifies (e.g., retrieves, selects, determines, or receives) a port criterion with which to evaluate port numbers that are included in packets that are addressed to (or received from) a host that is associated with (e.g., assigned to) the duplicate IP address. While in the error mode, the routers may update a port number that is included in outgoing packets sent by one of the affected hosts to ensure that the port number satisfies the identified port criterion. Upon one of the routers receiving an inbound packet addressed to the duplicate IP address, the router determines for which host the packet is intended (e.g., which of the two routers should route the packet to the endpoint device) based on whether the destination port number in the packet satisfies the port criterion. In this manner, the routers can use the destination port number included in response packets to route such packets to the appropriate host, even before the duplicate IP address error condition is resolved. For packets that are addressed to the duplicated IP address but are not response packets, the router may route the packet to the host for which it has advertised a route and/or may forward the packet to the other affected router.

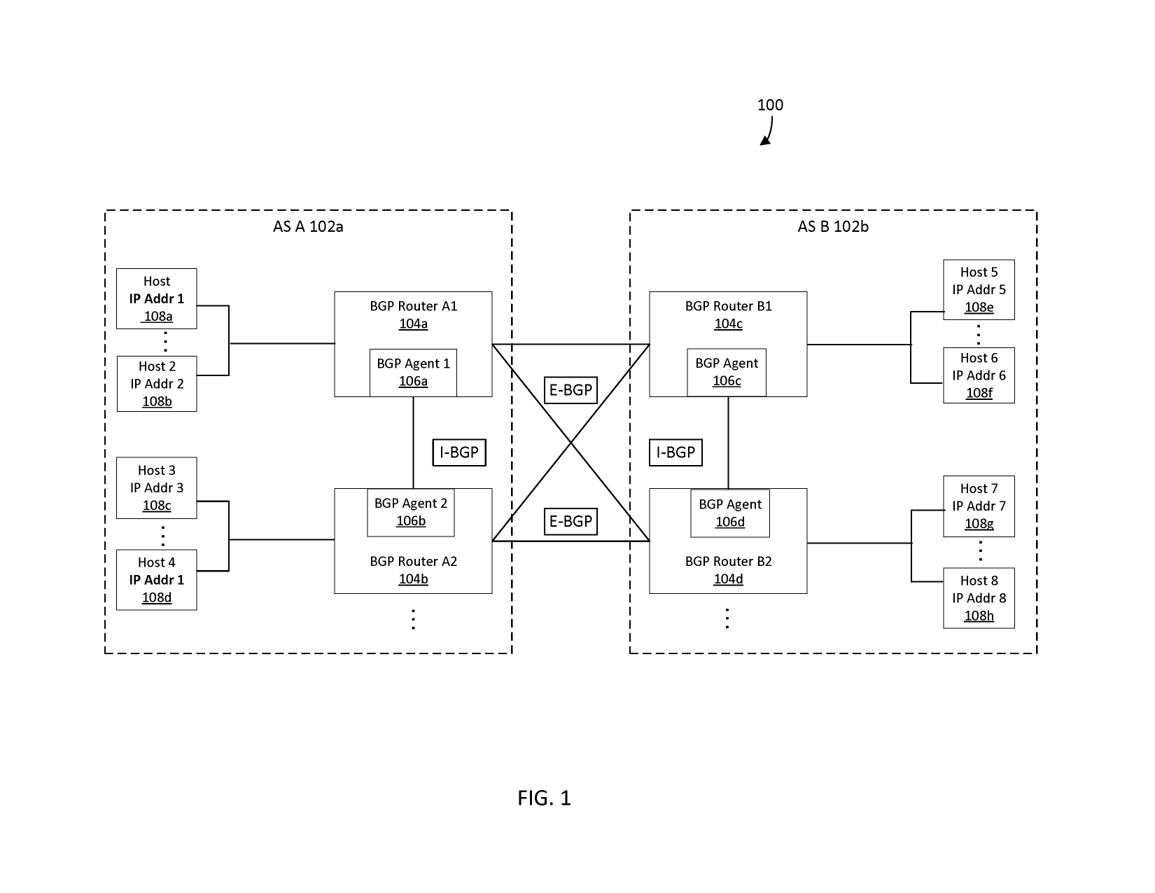

Additional details regarding systems and methods for network routing errors caused by duplicate IP addresses are described with reference to FIGS. 1-6.

FIG. 1 is a block diagram of a network system 100 that includes multiple autonomous systems (ASes) and border gateway protocol (BGP) routers. As used herein, an AS may include a collection of connected IP networks that is operated by a single entity or organization. The AS may include a unit of a larger network, such as the Internet, that functions as a single entity and can communicate with other ASes using the border gateway protocol. An AS may be assigned a unique number called an Autonomous System Number (ASN) by a regional Internet registry (RIR) to identify it within the global network. In some examples, the ASN is used by a BGP router(s) to route traffic within and across ASes. Each of the ASes may include one or more internal routing devices (e.g., switches or routers, such as BGP routers, that are included within the AS and domain name system (DNS) servers). The BGP routers can route packets within a single ASN (e.g., using an internal border gateway protocol, or I-BGP) and/or across ASes (e.g., using an external border gateway protocol, or E-BGP). Although the examples herein describe the use of BGP routers, it should be understood that different types of routers can perform similar procedures without departing from the scope of the disclosure.

In the example of FIG. 1, the network system 100 includes two ASes 102 (AS A 102a and AS B 102b), each of which includes two BGP routers 104. For example, AS A 102 includes BGP router A1 104a and BGP router A2 104b, and AS B 102b includes BGP router B1 104c and BGP router B2 104d. Broadly, the BGP routers 104 are responsible for routing packets between hosts 108 of the network system 100 based on the IP addresses of the hosts 108 and ports associated with services provided by the hosts 108. For example, the BGP routers can route a packet to a particular service of a particular host (e.g., a service of host 1 108a, host 2 108b, host 3 108c, host 4 108d, host 5 108e, host 6 108f, host 7 108g, or host 8 108h) using the IP address of the host and the port number of the service.

Each BGP router 104 includes a BGP agent 106 running on the router. The BGP agent 106 is responsible for selecting (e.g., determining) and advertising routes, among other tasks. The route advertisements may be used by other BGP routers to identify routes for packet transmission. Once a BGP agent 106 has determined a route to a particular host (e.g., a host having a particular IP address), the BGP agent 106 advertises the route by broadcasting an advertisement for the route to other routers. The advertisement includes information about IP addresses (or groups of contiguous IP addresses, referred to as subnets) for which the agent has identified a route. For example, the advertisement may include an IP address or network prefix (e.g., a subnet) being advertised, which is typically represented as an IP address followed by a prefix length (e.g., 1.1.1.1/24, where 24 is the prefix length) and a “next hop” that indicates the IP address of the router that should be used as the next hop to reach the advertised prefix.

Packets that are transmitted from one host to another typically include a destination IP address (e.g., the IP address of the destination host), an indication of a destination port (e.g., a port number that is associated with a desired application or service running on the destination host), a source IP address (e.g., the IP address of the host that is sending the packet), and a source port number (e.g., the number of the port that is associated with an application or service of the host that is sending the packet). The destination port number is used in conjunction with the destination IP address to determine a particular port of a host (e.g., an endpoint device) to which the packet is routed. In addition to the addressing information, the packet includes data (e.g., a payload).

As an example, a packet may include the following information (though not necessarily in this order):

Packet: [source IP address, source port number, destination IP address, destination port number, payload]

When responding to a received packet, a host may use the source IP address and source port number in the received packet as a destination IP address and destination port number (respectively). For example, the receiving host may respond to a received packet by addressing a response packet to the same IP address and port number as those included in the received packet (e.g., the source IP address and source port number).

As previously discussed, in some cases, a single IP address may erroneously be assigned to (e.g., associated with) with multiple hosts. For example, an IP address may be included on one or more domain name service (DNS) servers twice, once in which it is associated with a first host and once in which it is associated with a second host. Similarly, a range of IP addresses (such as a subnet) may be duplicated such that it is associated with two separate groups of hosts. IP address duplication leads to routing ambiguity when a packet is addressed to a duplicated IP address or subnet, and can result in routing errors, mis-delivered packets, and/or network outages.

In the example of FIG. 1, both host 1 108a and host 4 108d have (e.g., are associated with, assigned to) the same IP address (IP Address 1). In general, a route to a single IP address or subnet is advertised by a single router within an AS. In this example, however, both BGP router A1 and BGP router A2 may advertise a route to IP Address 1 (or to a subnet that includes IP Address 1).

Thus, if host 8 108h (for example) sends a packet addressed to IP Address 1 (e.g., a packet that includes IP Address 1 as a destination IP address), the endpoint device (e.g., the host device to which the packet is delivered) is not deterministic—the packet may end up at either host 1 or host 4, depending on the route taken, or may not be delivered at all.

As an example of this potential failure, suppose host 1 108a sends a packet to host 8 108h that includes a source IP address (IP address 1), a source port (e.g., port 2), a destination IP address (IP address 8), and a destination port (e.g., port 10). Host 8 108h may receive the first packet and respond by sending a response packet that is intended to go to host 1 108a and includes a destination IP address of IP address 1. Depending on whether this packet is routed to BGP router A1 or BGP router A2, the packet may end up at the intended endpoint device (host 1), or at the other device with the same IP address (host 4). In some cases, the response packet may not be delivered at all.

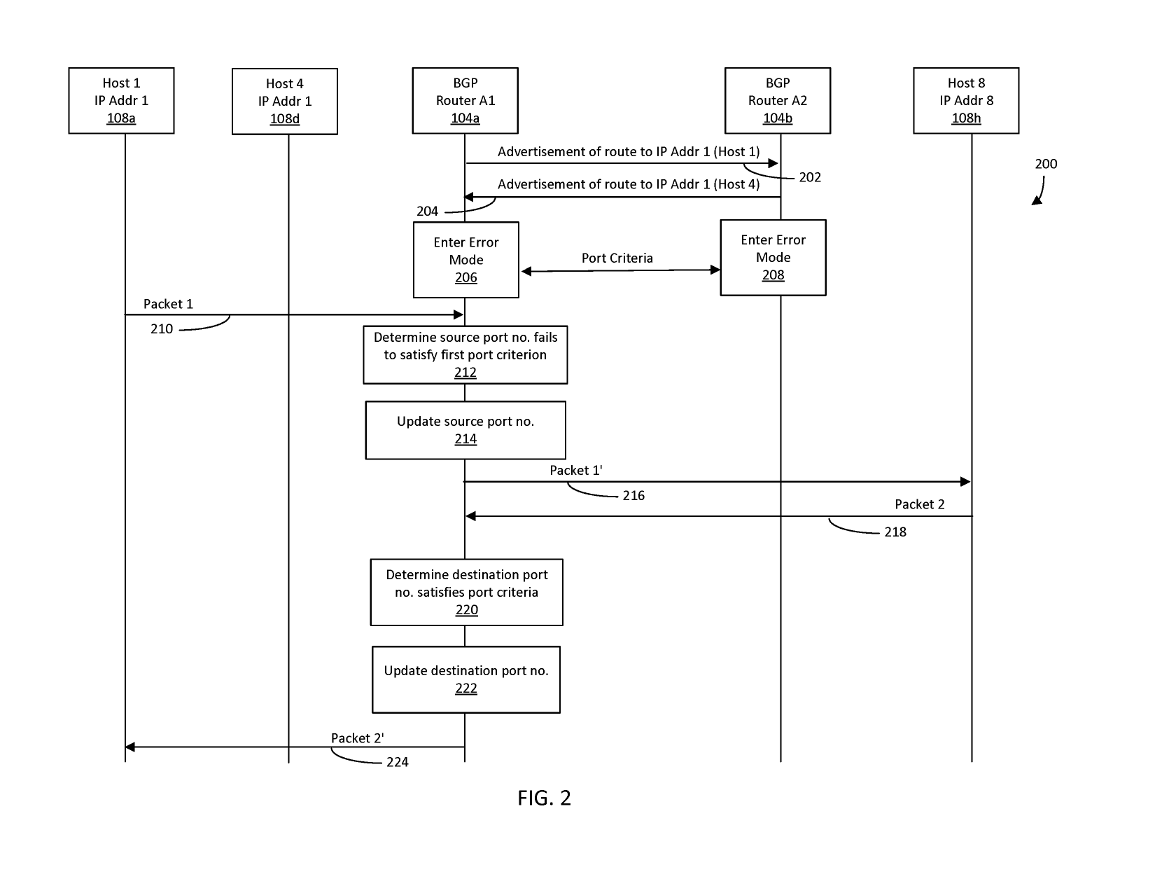

In the above-described scenario, BGP router A1 104a may advertise a route to IP Address 1 and may also receive an advertisement for a route to IP Address 1 from BGP router A2 104b (and vice versa). Thus, both routers may determine that the other router’s advertisement is indicative of an error condition (a duplicate IP address), since neither router should be receiving advertisements for routes to IP addresses that the router is already advertising. In this case, BGP router A1 104a and/or BGP router A2 104b may enter an error mode in which the routers handle packets to/from IP address 1 differently from other packets, as described in more detail with reference to FIGS. 2-4. In examples, recognition of an error condition by each router 104 may be facilitated in multiple ways. For example, each router 104 may store a hashed media access control (MAC) address of each host 108 (e.g., Host 1 or Host 4) physically connected to that router 104 (e.g. 104a or 104b) or for which that router 104a or 104b is configured as the direct BGP router in AS A 102a. When BGP router A1 104a advertises a route to IP Address 1, the advertisement may include the hashed MAC address of host 108a. BGP router A1 104a may also receive an advertisement for a route to IP Address 1 from BGP router A2 104b that includes a hashed MAC address of host 108d. In other examples the hashed MAC address may not be included in the advertisement, but each router 104a and 104b can query the other for the hashed MAC address associated with an IP address advertised by the other router. For example, if router 104a receives an advertisement for IP Address 1 from router 104b, and router 104a determines that IP Address 1 is already associated with a host 108a that is directly attached to router 104a, router 104a may query router 104b for the hashed MAC address associated by router 104b with IP Address 1, or vice versa. Thus, both routers 104a and 104b may determine that the other router’s advertisement is indicative of an error condition (a duplicate IP address), since each router 104 will be able to compare the hashed MAC address associated with the advertisement for IP address 1 received from the other router to its stored hashed MAC address for that IP address 1.

FIG. 2 depicts an example swim lane diagram 200 in which aspects of the present technology may be performed by one or more routers (e.g., a BGP router or another type of router) of a network and one or more hosts connected to the network. In some examples, aspects of the present technology may be performed by an agent of the router (e.g., a BGP agent) and/or other components of a router. Swim lane diagram 200 represents device and routing behaviors for the scenario described with reference to FIG. 1, in which both host 1 and host 4 have the same IP address (IP address 1).

In the example of FIG. 2, BGP router A1 104a has previously established a route to host 1 108a (IP address 1) and at 202, BGP router A1 104a transmits an advertisement for that route to BGP router A2 104b. Similarly, BGP router A2 104b has previously established a route to host 4 108d (also IP address 1) and at 204, BGP router A2 104b transmits an advertisement for that route to BGP router A1 104a.

In response to receiving, from BGP router A2 104b, an advertisement of a route to a host (host 4 108d) that has the same IP address as a host to which a route is advertised by BGP router A1 (host 1 108a), at 206, BGP router A1 104a enters an error mode. Similarly, in response to receiving from BGP router A1 104a, an advertisement of a route to a host (host 1 108a) that has the same IP address as a host to which a route is advertised by BGP router A2 104b (host 4 108d), at 206, BGP router A2 104b enters the error mode.

In some examples, when BGP router A1 104a enters the error mode, BGP router A1 104a transmits information (e.g., by sending a notification) to BGP router A2 104b (or vice versa) that may include port criteria that the two routers will use to handle subsequent packets that are addressed to or from the duplicate IP address (IP address 1). The port criteria may divide the port space (e.g., the port numbers) between the two routers and may specify, for packets addressed to the duplicate IP address, which port numbers will be routed to which hosts. For example, the port criteria may be used to determine which router (BGP router A1 104a or BGP router A2 104b) will route packets that are addressed to IP address 1 based on whether the destination port number satisfies or fails a first port criterion assigned to BGP router A1 104a and/or a second port criterion assigned to BGP router A2 104b.

In some examples, the port criteria effectively assign a first subset of port numbers for IP address 1 to BGP router A1 104a and a remaining second subset of port numbers for IP address 1 to BGP router A2 104b. For example, BGP router A1 104a may handle even-numbered port numbers for IP address 1 and BGP router A2 104b may handle odd-numbered port numbers for IP address 1. In this case, a packet addressed to IP address 1 and received at BGP router A1 104a will satisfy the first port criterion for BGP router A1 104a if the destination port number is an odd number (in which case BGP router A1 104a will route the packet to host 1108a), and will fail to satisfy the port criterion for BGP router A1 104a if the destination port number is an even number (in which case BGP router A1 104a will forward the packet to BGP router A2 104b for delivery to host 4 108d). Router A2 104b may use a second port criterion that is the complement of the first port criterion used by BGP router A1 104b (e.g., that includes some or all of the port numbers that fail to satisfy BGP router A1’s port criterion). That is, a packet addressed to IP address 1 and received at BGP router A2 104b will satisfy the second port criterion if the destination port number is an even number (in which case the packet will be routed to host 4108d), and will fail to satisfy the second port criterion if it is an even number (in which case the packet will be forwarded to BGP router A1 104a for delivery to host 1 108a).

In some examples, the two routers may negotiate the port criteria to accommodate fixed port numbers of a particular host that are assigned to web servers or other services. For example, a BGP router A1 104a may, upon detecting a duplicate IP address, notify BGP router A2 104b that host 1 108a (served by the BGP router A1 104a) includes a fixed port number (e.g., a port number that is fixed for a particular service). The port criterion for BGP router A1 104a will then be satisfied by that fixed port number (e.g. the fixed port number will be assigned to BGP router A1 to handle and will not be included in the port numbers that satisfy the port criterion for BGP router A2). In some examples, the routers may divide the port space based on each router’s loopback IP address (e.g., the router having the lower loopback IP address will handle odd port numbers and the router having the higher loopback IP address will handle even port numbers). In some examples, the routers may divide the port space based on a simple network management protocol (SNMP) interface management information base (MIB) available to both routers. In some examples, each router is able to determine the port criterion applicable to its own traffic without the need to actually communicate with the other router.

While in the error mode, each router may ensure that port numbers included in outgoing packets from IP address 1 satisfy the port criterion for that router by updating the port number in the packet to satisfy the port criterion if the initial source port number fails to satisfy the port criterion. The router may then maintain a mapping of the original port number and the updated port number that can be used to re-address response packets to the original port number if and when they are received. In other examples, whenever, in an error condition, an outgoing packet is received with a port number that does not meet the port criterion for that router, the router may simply add one to the port number (e.g., in the case of dividing the port number space into odd and even ports), and then subtract one when re-addressing response packets. Updating the port number in this way provides a method of keeping track of which host sent the packet—and therefore, to which host a response should be routed.

In some cases, the division of the port space that is determined by BGP router A1 104a and/or BGP router A2 104b changes BGP attributes that are used to advertise the duplicated IP address (or subnet) to other routers. (BGP attributes are parameters that other BGP routers use to make effective routing decisions). For example, the changed advertisement may be used in routing decisions by neighboring routers to forward packets destined for the duplicate IP address (or subnet) to one of the two routers based on whether the destination port is even or odd (assuming the port criteria divides the port space into even and odd port numbers).

In the example, of FIG. 2, BGP router A1 104a and BGP router A2 104b have agreed (or both independently determined) that BGP router A1 104a will handle packets addressed to IP address 1 that have even-numbered port numbers (which it will route to host 1 108a), and BGP router A2 104b will handle packets addressed to IP address 1 that have odd-numbered port numbers (which it will route to host 4 108d). That is, BGP router A1 104a has identified a port criterion that is satisfied by even numbers, and BGP router A2 104b has identified the complementary port criterion of being satisfied by odd numbers. As previously mentioned, other, more complex port criteria may be identified by the routers.

In the example of FIG. 2, at 210, host 1 108a transmits a packet (packet 1) that is addressed to port number 3 of host 8 108h. As an illustrative example, assume that a first port criterion associated with BGP router A1 is satisfied when the port number is an odd number, and packet 1 includes the following:

Packet 1: [Source IP address = IP address 1; source port number = port number 6, destination IP address = IP address 8; destination port number = port number 3; payload= payload 1]

At 212, BGP router A1 104a determines that the source port number in packet 1 fails to satisfy the first port criterion (e.g., it is an even number).

In this case, to ensure that any response to this packet from host 8108h is routed to host 1108a and not host 4108d, and based on a determination that the (even) source port number fails to satisfy the first port criterion associated with BGP router A1104a (and therefore is not within the subset of port numbers to be handled by BGP router A1104a), at 214 BGP router A1104a updates the source port number in the outgoing packet to an odd port number, such as port number 7. The updated packet is depicted in FIG. 2 as packet 1’, and includes the following (with the updated portion in bold):

Packet 1’: [source IP address = IP address 1; source port number = 7, destination IP address = IP address 8; destination port number = 3; payload= payload 1]

In some examples, BGP router A1 104a updates the port number by adding or subtracting a (predetermined) number from the port number, such as by adding or subtracting 1 to/from the port number to change it to an even number. Many possible computational adjustments may be used for this purpose. In some examples, BGP router A1 104a saves the original source port number for use in any subsequent responses to packet 1 (e.g., so that BGP router A1 104a can route the response to the host 1 port having the original source port number). Although not shown in FIG. 2, in some examples, the source port number in a packet sent by host 1 108a and received by BGP router A1 satisfies the first port criterion of BGP router A1 as-is and therefore BGP router A1 refrains from updating the source port number before forwarding packet 1 to host 8 108h.

At 216, BGP router A1 forwards the updated packet (packet 1’) along its route to host 8 108h (such as by forwarding packet 1’ to another router, not shown).

In the example of FIG. 2, host 8 108h responds to receiving packet 1’ by generating a response packet that includes the updated source port number as a destination port. For example, at 218, host 8 108h transmits a response packet (packet 2) to host 1 108a that includes the following:

Packet 2: [Source IP address = IP Address 8; source port number = 3; destination IP address = IP address 1; destination port number = 7; payload = payload 2]

At 220, BGP router A1 104a receives packet 2 and determines that the destination port number of packet 2 satisfies the first port criterion (e.g., it is an odd number).

At 222, BGP router A1 104a updates the destination port number of packet 2 to revert to the original source port number of packet 1 (e.g., to revert from port number 7 to port number 6). Router A1 104e then routes the updated packet (packet 2’) to host 1, where packet 2’ includes the following:

Packet 2’: [Source IP address = IP Address 8; source port number = 3; destination IP address = IP address 1; destination port number = 6; payload = payload 2]

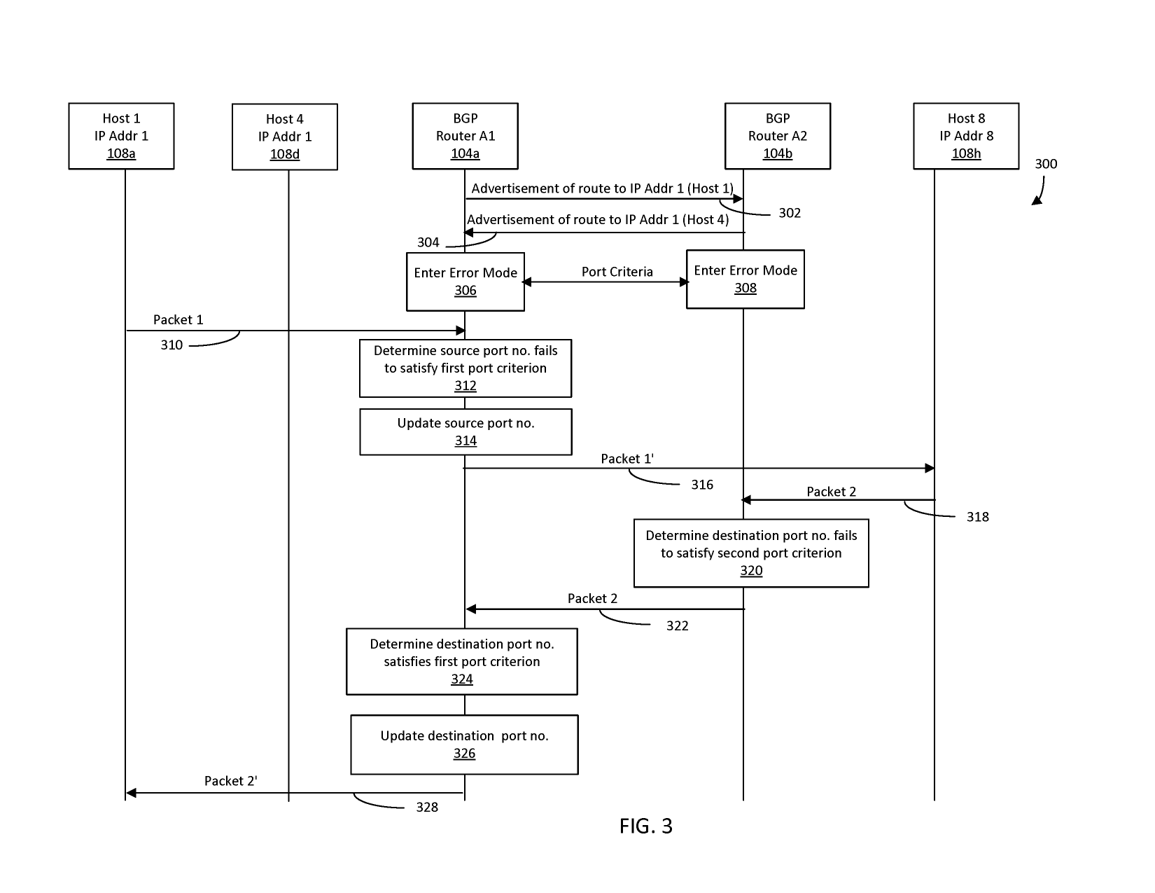

FIG. 3 depicts an example swim lane diagram 300 in which aspects of the present technology may be performed by one or more routers (e.g., a BGP router or another type of router) of a network and one or more hosts connected to the network. In some examples, aspects of the present technology may be performed by an agent of the router (e.g., a BGP agent) and/or other components of a router. Like in swim lane diagram 200 of FIG. 2, swim lane diagram 300 represents device and routing behaviors for the scenario described with reference to FIG. 1, in which both host 1 and host 4 have the same IP address (IP address 1). The scenario depicted in FIG. 3 is similar to that depicted in FIG. 2, but in FIG. 3, the response packet initially arrives at BGP router A2 104b and is then forwarded to BGP router A1 104a for delivery to host 1 108a.

In the example of FIG. 3, BGP router A1 has previously established a route to host 1 (IP address 1) and at 302, BGP router A1 104a transmits an advertisement for that route to BGP router A2 104b. Similarly, BGP router A2 has previously established a route to host 4 (IP address 1) and at 304, BGP router A2 104e transmits an advertisement for that route to BGP router A1 104f.

In response to receiving, from BGP router A2104b, an advertisement of a route to a host (host 4) that has the same IP address as a host to which a route is advertised by BGP router A1 (host 1), at 306, BGP router A1104a enters an error mode such as described with reference to FIG. 2. Similarly, in response to receiving, from BGP router A1104a, an advertisement of a route to a host (host 1108a) that has the same IP address as a host to which a route is advertised by BGP router A2104b (host 4108d), at 308, BGP router A2104b enters the error mode.

In the example of FIG. 3, at 310, host 1 108a transmits a packet (packet 1) that is addressed to port number 3 of host 8. Like with FIG. 2, assume that a first port criterion associated with BGP router A1 104a is satisfied when the port number is an odd number, and packet 1 includes the following:

Packet 1: [Source IP address = IP address 1; source port number = port number 6, destination IP address = IP address 8; destination port number = port number 3; payload= payload 1]

At 312, BGP router A1 determines that the source port number fails to satisfy the first port criterion.

In this case, to ensure that any response to this packet from host 8 108h is routed to host 1 108a and not host 4 108d, and based on a determination that the (even) source port number fails to satisfy the first port criterion associated with BGP router A1 104a (and therefore is not within the subset of port numbers to be handled by BGP router A1), at 314 BGP router A1 updates the source port number in the outgoing packet to an odd port number, such as port number 7. The updated packet is depicted in FIG. 3 as packet 1’, and includes the following (with the updated portion in bold):

Packet 1’: [Source IP address = IP address 1; source port number = 7, destination IP address = IP address 8; destination port number = 3; payload= payload 1]

At 316, BGP router A1 forwards the updated packet (packet 1’) along its route to host 8 108h (such as by forwarding packet 1’ to another router, not shown).

At 318, host 8 108h responds by sending a response packet (packet 2), which arrives at BGP router A2 104b.

Packet 2: [Source IP address = IP Address 8; source port number = 3; destination IP address = IP address 1; destination port number = 7; payload = payload 2]

At 320, BGP router A2 104b determines that a destination port number of packet 2 fails to satisfy a second port criterion associated with BGP router A2 104b (because it is an odd number). In response to this determination, at 322, BGP router A2 104b forwards packet 2 to BGP router A1 104a. In examples, BGP router A2 104b knows to send packet 2 to BGP router A1 because BGP router A2 has previously communicated with BGP router A1 regarding entering the error mode and determining the port criteria. In other examples, BGP router A2 may have independently determined (without communicating with BGP router A1) that it is in error mode and forwards packet 2 based on being in error mode and based on the advertisement received at operation 302.

At 324, BGP router A1 determines that the destination port satisfies the first port criterion of BGP router A1 (meaning that it is intended for host 1, to which BGP router A1 104a has established a route). At 326, in response to determining that the destination port number satisfies the first port criterion associated with BGP router A1, BGP router A1 updates the destination port number to revert to the original source port number (e.g., the source port number that was included in packet 1).

At 328, BGP router A1 routes the updated packet (e.g., packet 2’) to host 1 108a.

Packet 2’: [Source IP address = IP Address 8; source port number = 3; destination IP address = IP address 1; destination port number = 6; payload = payload 2]

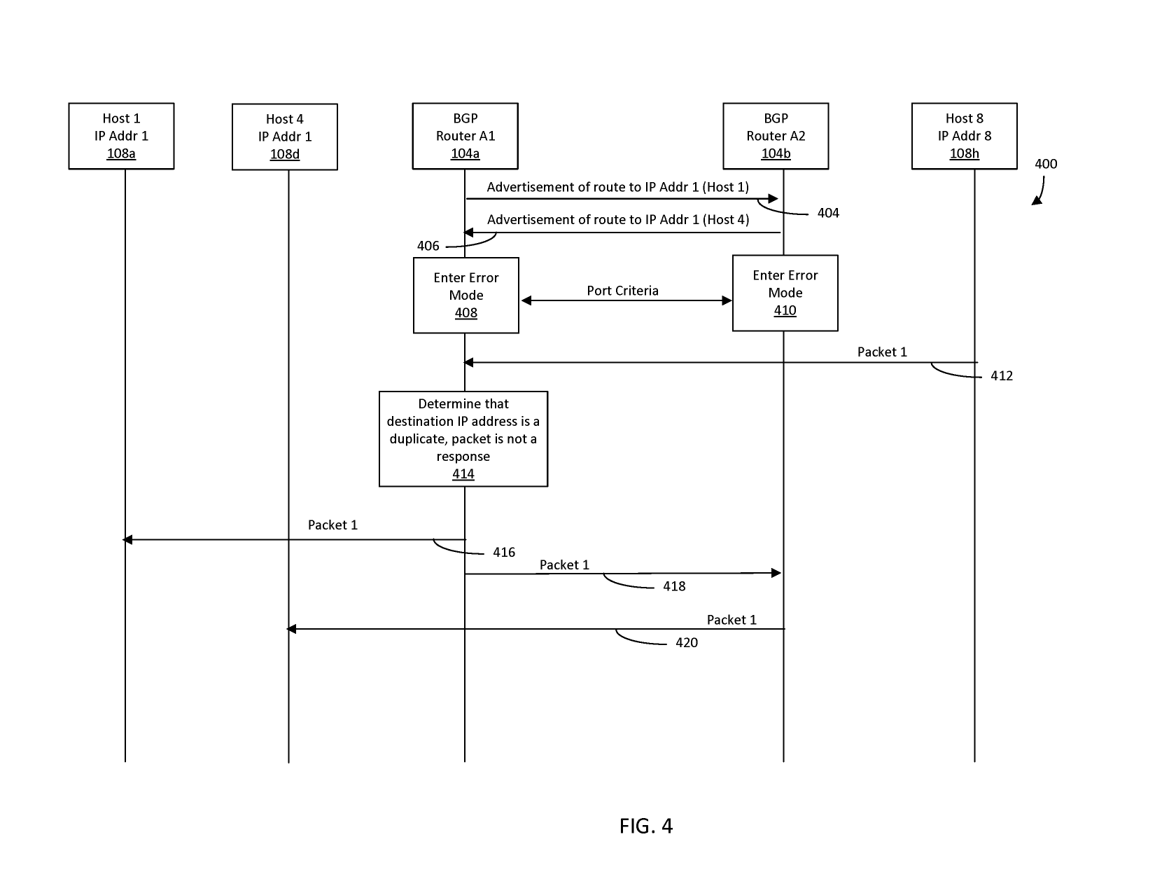

FIG. 4 depicts an example swim lane diagram 400 in which aspects of the present technology may be performed by one or more routers (e.g., a BGP router or another type of router) of a network and one or more hosts connected to the network. In some examples, aspects of the present technology may be performed by an agent of the router (e.g., a BGP agent) and/or other components of a router. Like in swim lane diagram 200 of FIG. 2, swim lane diagram 400 represents device and routing behaviors for the scenario described with reference to FIG. 1, in which both host 1 and host 4 have the same IP address (IP address 1). FIG. 4 depicts a scenario similar to that of FIG. 2 and FIG. 3, in which BGP router A1 104a and BGP router A2 104b have each entered an error mode (at 408, 410) based on receiving advertisements from each other (advertisements 404, 406), and have identified port criteria to use while operating in the error mode. In FIG. 4, however, a packet is sent by host 8 108h (at 412) that is addressed to the duplicated IP address (IP Address 1) and is not a response to a packet previously received from a host with the duplicated IP address (host 1 or host 4). In some examples, a router can determine whether a packet received from a source host is a response packet based on information included in the packet and/or based on whether there was a previous outgoing packet addressed to the current source host from the current destination host. A router may maintain a list of outgoing packets and their destination hosts that provides an indication of whether an incoming packet from a source host is a response to an earlier outgoing packet. For example, the router may maintain a lookup table of tuples of source-IP/destination-IP/source-PORT, destination-PORT packets that have been sent on behalf of a particular IP address. The entries in the list may be temporary and may expire after a threshold time duration. Other methods for determining whether a packet is a response packet are possible and contemplated.

When the packet is not a response, BGP router A1 104a and BGP router A2 104b cannot use the source port number associated with each host having the duplicated IP address as a means for disambiguating the intended host device for packet 1 (e.g., host 1 or host 4). In this case, if BGP router A1 104a (for example) receives packet 1 from host 8 108h and packet 1 has the duplicated IP address as the destination IP address, BGP router A1 104a may route packet 1 to both host 1 108a and host 4 108b (by forwarding the packet to BGP router A2 104b). That is, at 416, BGP router A1 may route packet 1 to host 1108a, and at 418 BGP router A1 may forward packet 1 to BGP router A2 104b. At operation 420, BGP router A2 104b forwards packet 1 to host 4 108b. In most cases, only one of these two recipient hosts (host 1 and host 4) will respond with a valid response packet, and the other host will respond with an error message. The valid response packet can then be routed to host 8 108h. In examples a loop-back condition may also be prevented, e.g., by configuring BGP router A2104b to not, when operating in the error condition, forward the packet 1 back to BGP router A1 (in addition to forwarding packet one to host 4 108b). For example, each of the BGP routers 104 may be configured to never, when in an error condition, forward a packet other back to the other router from which it is received.

In some cases, instead of routing such a packet to both hosts having the duplicated IP address, a router may send an error message to the source host (e.g., host 8 104h).

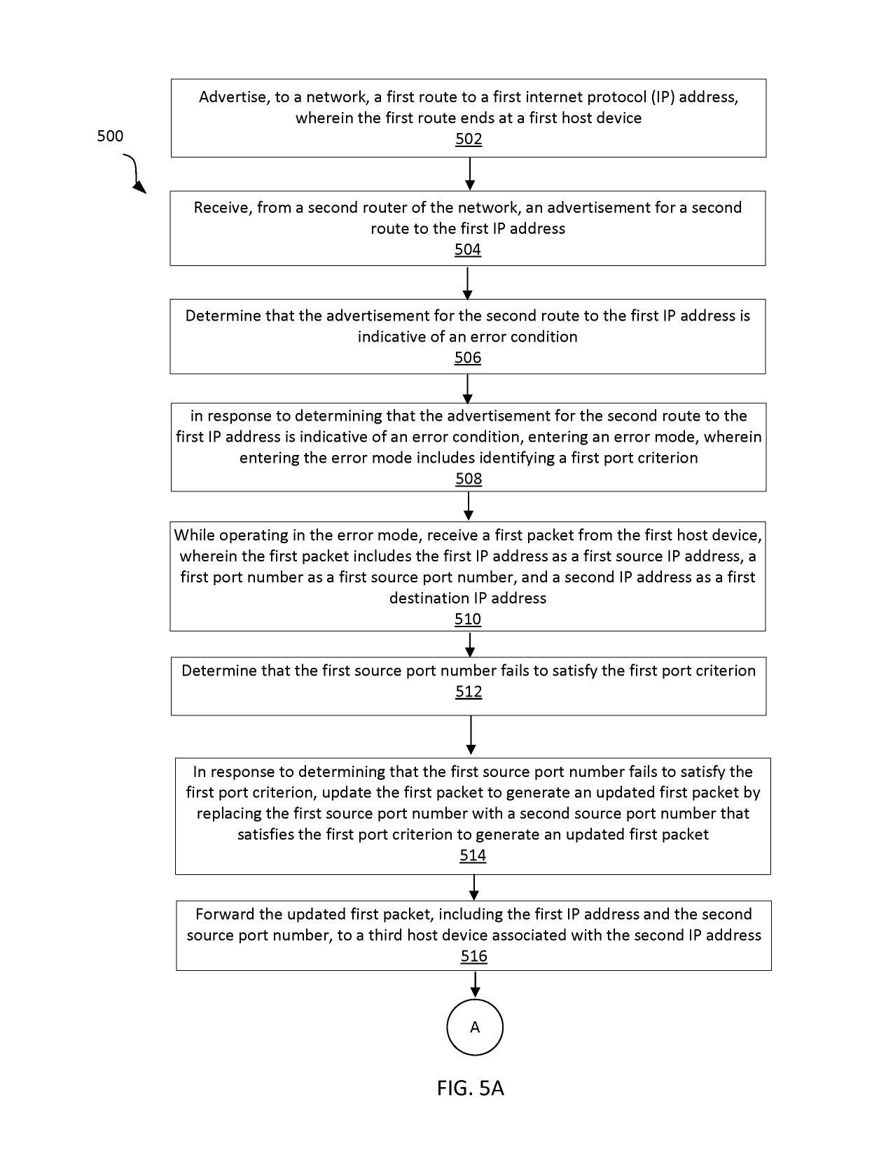

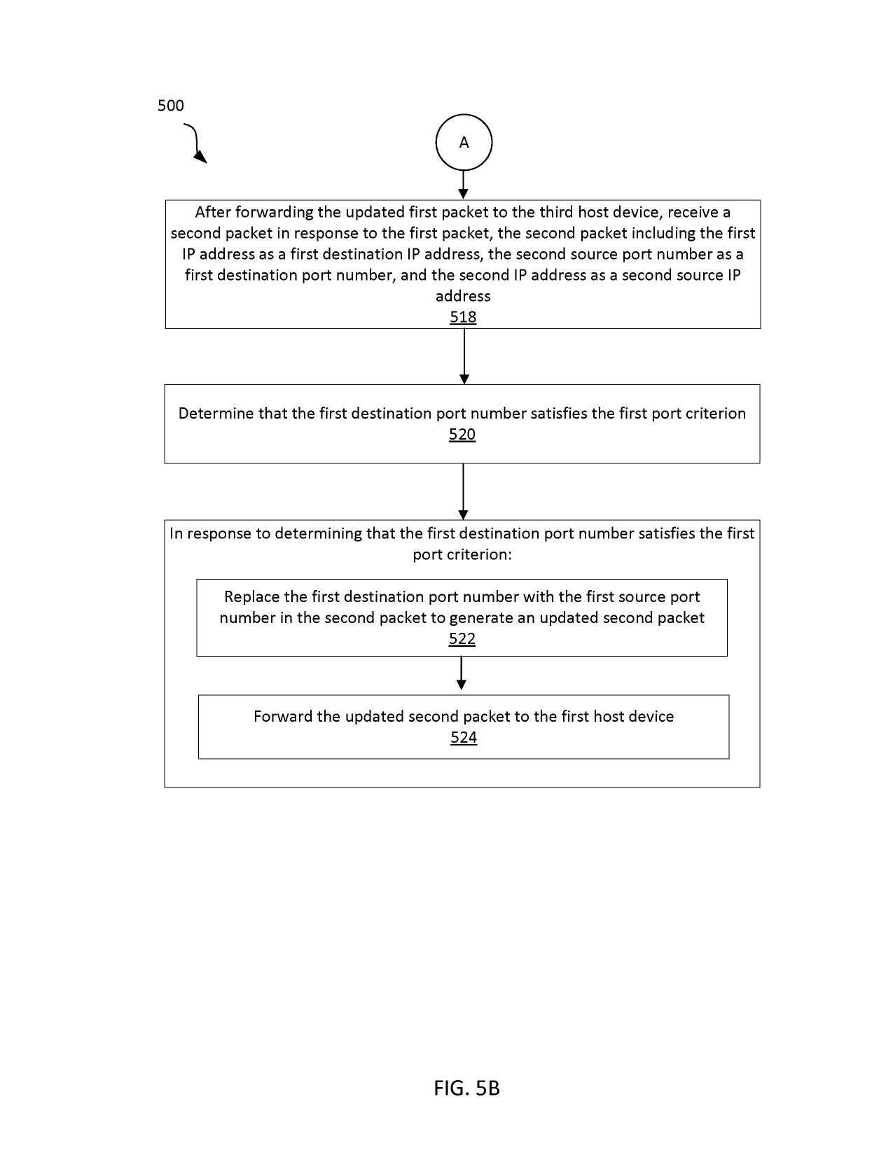

FIGS. 5A-5B depict an example method 500 according to aspects of the present application. In examples, one or more of the operations of FIGS. 5A-5B can be performed by a router, such as a BGP routers A1 104a, BGP router A2 104b, router A1 104a, router A2 104b, or by another router(s). In some cases, operations shown in FIGS. 5A-5B can be rearranged and/or omitted, and/or additional operations can be performed, without departing from the scope of the invention.

At 502, a first router (e.g., router A1 104a in the example of FIGS. 2-4) advertises, to a network (e.g., via a broadcast communication), to a network, a first route to a first IP address, where the first route ends at a first host device (e.g., a first host that is associated with the first IP address, such as host 1 108a having IP address 1).

At 504, the first router receives, from a second router of the network (e.g. router A2 104b), an advertisement for a second route to the first IP address.

At 506, the first router determines that the advertisement for the second route to the first IP address is indicative of an error condition. For example, the first router determines that the advertisement is indicative of an error condition based on the first router having previously established a route to the first IP address and/or having advertised the first IP address.

At 508, in response to determining that the advertisement for the second route to the first IP address is indicative of an error condition, the first router enters an error mode, where entering the error mode includes identifying a first port criterion (e.g., a port criterion to be used by the first router). In some examples, entering the error mode includes identifying the first port criterion either independently or based on negotiations (e.g., communications) with the second router. In some examples, the two routers may exchange port criteria that includes a first port criterion to be used by the first router and a second port criterion to be used by the second router, where the first port criterion is satisfied when a port number is included in a first set of port numbers and the second port criterion is satisfied when a port number is included in a second set of port numbers that is different from the first set. In some examples, the second port criterion is a complement of the first port criterion, such as when the first port criterion is satisfied by odd port numbers and the second port criterion is satisfied by even numbers. In some examples, the first port criterion and second port criterion divide the port space (e.g., the port numbers) between the first router and the second router. In some examples, while the first router is operating in the error mode, the first router updates source port numbers in outgoing packets as needed to ensure that the source port numbers satisfy the first port criteria, such as described with reference to operation 508, below.

At 510, while operating in the error mode, the first router receives a first packet from the first host device, where the first packet includes the first IP address as a first source IP address, a first port number as a first source port number, and a second IP address as a first destination IP address, such as described with reference to operations 210 FIG. 2.

At 512, the first router determines that the first source port number fails to satisfy the first port criterion, such as described with reference to operation 212 of FIG. 2. For example, if the first port criterion is satisfied when the source port number is an even number and, in the first packet, the first source port number is an odd number, then the first source port number fails to satisfy the first port criterion. Conversely, in this example, if the first source port number is an even number, the first source port number would satisfy the first port criterion.

At 514, in response to determining that the first source port number fails to satisfy the first port criterion, the first router updates the first packet to generate an updated first packet by replacing the first source port number with a second source port number that satisfies the first port criterion to generate an updated first packet, such as described with reference to operation 214 of FIG. 2. Returning to the example above, the first router may replace an odd numbered source port number with an even numbered source port number. In some examples, if the first source port number satisfies the port criterion, the router refrains from updating the first source port number in the packet.

At 516, the first router forwards the updated first packet, including the first IP address and the second source port number, to a third host device associated with the second IP address, such as shown at 216 of FIG. 2, for example. In some examples, the router forwards the updated first packet by sending it to another router along the path to the third host device (e.g., sending it to the next hop). In some examples, the router forwards the updated first packet by sending the updated first packet directly to the third host device.

At 518, after forwarding the updated first packet to the third host device, the first router receives a second packet in response to the first packet, where the second packet includes the first IP address as a first destination IP address, the second source port number as a first destination port number, and the second IP address as a second source IP address, such as shown at 218 of FIG. 2. For example, the router receives the third packet from the third host device (e.g., such as host 8108h as shown in FIGS. 2-3), possibly by way of other routers.

At 520, the first router determines that the first destination port number satisfies the first port criterion, such as described with reference to operation 220 of FIG. 2. For example, the first router determines the destination port number is an even number, which satisfies the first port criterion.

In response to determining that the first destination port number satisfies the first port criterion, at 522, the first router replaces the first destination port number with the first source port number in the second packet to generate an updated second packet, such as described with reference to operation 222 of FIG. 2. That is, the first router reverts the destination port number to the original source port number to ensure that the packet arrives at the intended port.

At 524, the router forwards the updated second packet (e.g., the packet with the updated destination port number, shown as packet 2’ in FIG. 2) to the first host device (e.g., to host 1108a, in the example of FIG. 2).

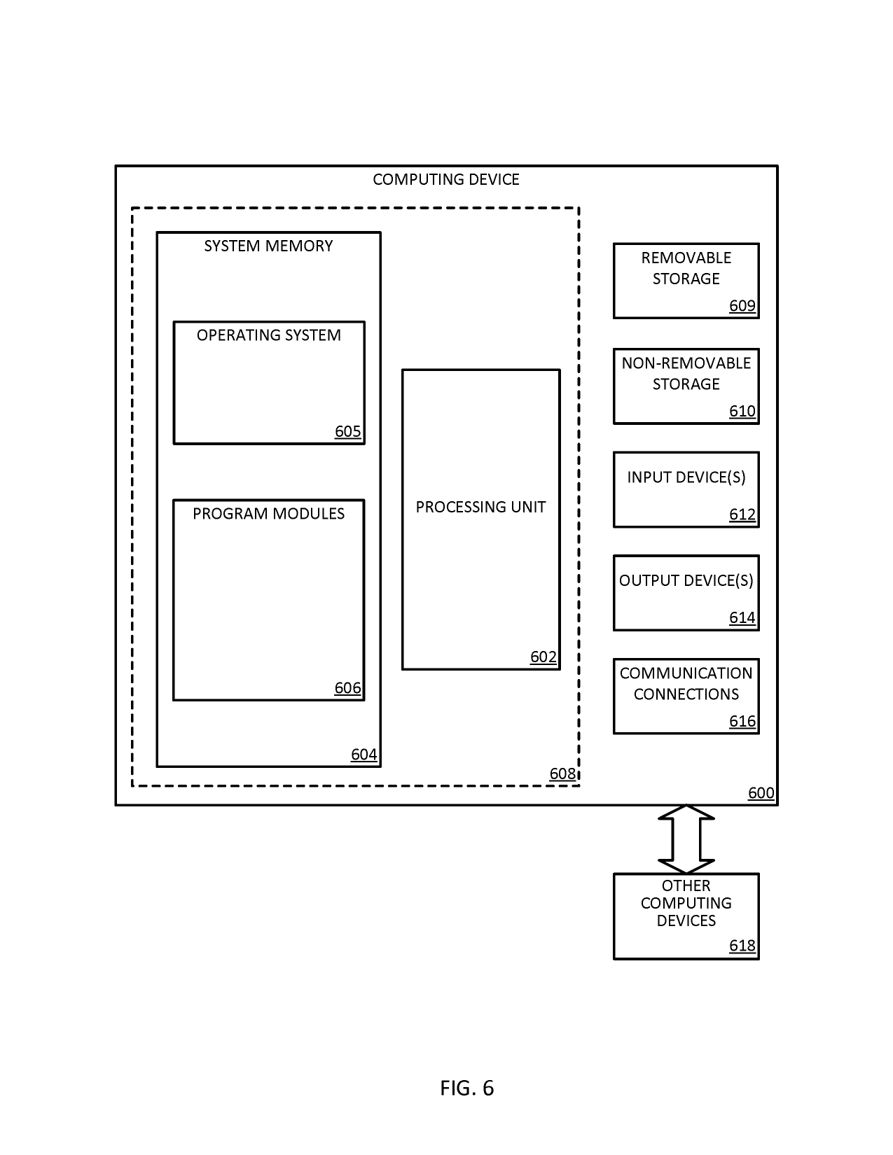

FIG. 6 depicts an example of a suitable computing device 600, portions of which may be used to implement a router (e.g., a BGP router or another type of router), and/or a host device. In its most basic configuration, computing device 600 typically includes at least one processing circuit 602 and memory 604. The processing circuit may include a hardware processor chip. Depending on the exact configuration and type of computing device, memory 604 (storing instructions to perform the methods disclosed herein) may be volatile (such as RAM), non-volatile (such as ROM, flash memory, etc.), or some combination of the two. This most basic configuration is illustrated in FIG. 6 by dashed line 606. The memory 604 stores instructions that, when executed by the processing circuit(s) 602, perform the processes and operations described herein. Further, computing device 600 may also include storage (removable 608, or non-removable 610) including, but not limited to, solid-state, magnetic disks, optical disks, or tape. Similarly, computing device 600 may also have input device(s) 614 such as keyboard, mouse, pen, voice input, etc., or output device(s) 616 such as a display, speakers, printer, etc. Additional communication connections 612 may also be included that allow for further communication with LAN, WAN, point-to-point, etc. Operating computing device 600 may also include geolocation devices 620, such as a global positioning system (GPS) device.

Operating computing device 600 typically includes at least some form of computer readable media. Computer readable media can be any available media that can be accessed by processing circuit 602 or other devices comprising the computing device. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term "modulated data signal" means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Although exemplary embodiments of systems and methods for mitigating network errors caused by duplicate IP addresses have been specifically described and illustrated herein, many modifications and variations will be apparent to those skilled in the art. Accordingly, it is to be understood that systems and methods for mitigating network errors caused by duplicate IP addresses according to principles of this disclosure may be embodied other than as specifically described herein.

What is claimed is:

1. A method performed at a first router, the method comprising:
advertising, to a network, a first route to a first internet protocol (IP) address, wherein the first route ends at a first host device;
receiving, from a second router of the network, an advertisement for a second route to the first IP address;
determining that the advertisement for the second route to the first IP address is indicative of an error condition;
in response to determining that the advertisement for the second route to the first IP address is indicative of an error condition, entering an error mode, wherein entering the error mode includes identifying a first port criterion;
while operating in the error mode, receiving a first packet from the first host device, wherein the first packet includes the first IP address as a first source IP address, a first port number as a first source port number, and a second IP address as a first destination IP address;
determining that the first source port number fails to satisfy the first port criterion;
in response to determining that the first source port number fails to satisfy the first port criterion, updating the first packet to generate an updated first packet by replacing the first source port number with a second source port number that satisfies the first port criterion to generate an updated first packet; and
forwarding the updated first packet, including the first IP address and the second source port number, to a third host device associated with the second IP address.

2. The method of claim 1, further comprising:
after forwarding the updated first packet to the third host device, receiving a second packet in response to the first packet, the second packet including the first IP address as a destination IP address, the second source port number as a first destination port number, and the second IP address as a second source IP address;
determining that the first destination port number satisfies the first port criterion; and
in response to determining that the first destination port number satisfies the first port criterion:
replacing the first destination port number with the first source port number in the second packet to generate an updated second packet, and
forwarding the updated second packet to the first host device.

3. The method of claim 1, further comprising:
in response to receiving the advertisement of the second route to the first IP address from the second router, sending a notification to the second router indicating an error condition.

4. The method of claim 3, wherein the notification includes an indication of port criteria including the first port criterion.

5. The method of claim 1, further comprising:
while operating in the error mode, receiving a third packet that includes the first IP address as a third source IP address, a third port number as a third source port number, and the second IP address as a second destination IP address;
determining that the third source port number satisfies the first port criterion;
in response to determining that the third source port number satisfies the first port criterion, forwarding the third packet, including the first IP address and the third source port number, to the third host device without updating the third source port number;
receiving a fourth packet in response to the third packet, the fourth packet including the first IP address as a third destination IP address, the third port number as a third destination port number, and the second IP address as a third source IP address;
determining that the third destination port number satisfies the first port criterion; and
in response to determining third destination port number satisfies the first port criterion, forwarding the third packet to the first host device.

6. The method of claim 1, further comprising:
while operating in the error mode, receiving a fifth packet from a third host device, the fifth packet including the first IP address as a fourth destination IP address, a third IP address as a fourth source IP address, and a fourth port number as a fourth destination port number,
determining that the first IP address is a duplicated IP address and the fifth packet is not a response packet; and
in response to determining that the first IP address is the duplicated IP address and the fifth packet is not the response packet, forwarding the fifth packet to the first host device and to the second router.

7. A router comprising:
at least one processor; and
memory, storing instructions that, when executed individually or collectively by the at least one processor, cause the router to perform a method, the method comprising:
advertising, to a network, a first route to a first internet protocol (IP) address, wherein the first route ends at a first host device;
receiving, from a second router of the network, an advertisement for a second route to the first IP address;
determining that the advertisement for the second route to the first IP address is indicative of an error condition;
in response to determining that the advertisement for the second route to the first IP address is indicative of an error condition, entering an error mode, wherein entering the error mode includes identifying a first port criterion;while operating in the error mode, receiving a first packet from the first host device, wherein the first packet includes the first IP address as a first source IP address, a first port number as a first source port number, and a second IP address as a first destination IP address;
determining that the first source port number fails to satisfy the first port criterion;
in response to determining that the first source port number fails to satisfy the first port criterion, updating the first packet to generate an updated first packet by replacing the first source port number with a second source port number that satisfies the first port criterion; and
forwarding the updated first packet, including the first IP address and the second source port number, to a third host device associated with the second IP address.

8. The router of claim 7, wherein the method further comprises:
after forwarding the updated first packet to the third host device, receiving a second packet in response to the first packet, the second packet including the first IP address as a destination IP address, the second source port number as a first destination port number, and the second IP address as a second source IP address;
determining that the first destination port number satisfies the first port criterion; and
in response to determining that the first destination port number satisfies the first port criterion:
replacing the first destination port number with the first source port number in the second packet to generate an updated second packet, and
forwarding the updated second packet to the first host device.

9. The router of claim 7, wherein the method further comprises:
in response to receiving the advertisement of the second route to the first IP address from the second router, sending a notification to the second router indicating an error condition.

10. The router of claim 9, wherein the notification includes an indication of port criteria including the first port criterion.

11. The router of claim 7, wherein the method further comprises:
while operating in the error mode, receiving a third packet that includes the first IP address as a third source IP address, the second IP address as a third destination IP address, and a third port number as a third source port number;
determining that the third source port number satisfies the first port criterion;
in response to determining that the third source port number satisfies the first port criterion, forwarding the third packet, including the first IP address and the third source port number, to the third host device without updating the third source port number;
receiving a fourth packet in response to the third packet, the fourth packet including the first IP address as a third destination IP address, the third port number as a third destination port number, and the second IP address as a third source IP address;
determining that the third destination port number satisfies the first port criterion; and
in response to determining third destination port number satisfies the first port criterion, forwarding the third packet to the first host device.

12. The router of claim 7, wherein the method further comprises:
while operating in the error mode, receiving a fifth packet from a third host device, the fifth packet including the first IP address as a fourth destination IP address, a third IP address as a fourth source IP address, and a fifth port number as a fourth destination port number;
determining that the first IP address is a duplicated IP address and the fifth packet is not a response packet;
in response to determining that the first IP address is the duplicated IP address and the fifth packet is not the response packet, forwarding the fifth packet to the first host device and to the second router.

13. A routing system comprising:
a first router connected to a network and configured to advertise, to the network, a first set of one or more routes to a first set of one or more Internet protocol addresses (IP addresses);
a second router connected to the network and configured to advertise, to the network, a second set of one or more routes to a second set of one or more Internet protocol addresses (IP addresses);
wherein the first router is configured to:
enter an error mode in response to receiving an advertisement from the second router advertising a route to a first IP address that is included in the first set of one or more IP addresses, wherein entering the error mode comprises identifying a first port criterion;
while operating in the error mode:
receive a first packet from a first host device associated with the first IP address, wherein the first packet includes the first IP address as a first source IP address, a first port number as a first source port number, and a second IP address as a first destination IP address;
determine that the first source port number fails to satisfy the first port criterion;
based on determining that the first source port number fails to satisfy the first port criterion, update the first packet to generate an updated first packet by replacing the first source port number with a second source port number that satisfies the first port criterion; and
forward the updated first packet, including the first IP address and the second source port number, to a third host device associated with the second IP address.

14. The routing system of claim 13, wherein the second router is configured to:
enter the error mode in response to receiving an advertisement from the first router advertising a route to the first IP address, wherein entering the error mode comprises identifying a second port criterion different from the first port criterion;
while operating in the error mode:
receive a second packet from a second host device associated with the first IP address, wherein the second packet includes the first IP address as a first source IP address, a third port number as a third source port number, and a third IP address as a second destination IP address, wherein the third IP address is associated with a third host device;
determine that the second source port number fails to satisfy the second port criterion;
based on determining that the second source port number fails to satisfy the second port criterion, update the second packet to replace the third source port number with a fourth source port number that satisfies the second port criterion; and
forward the updated first packet, including the first IP address and the third source port number, to the third host device.

15. The routing system of claim 13, wherein the first router is configured to send an indication of the first port criterion to the second router.

16. The routing system of claim 15, wherein the second router is configured to identify a second port criterion based on the first port criterion.

17. The routing system of claim 13, wherein the first router is configured to identify the first port criterion based on receiving a second port criterion from the second router.

18. The routing system of claim 13, wherein the first router is configured to identify the first port criterion based on a loopback IP address of the first router.

19. The routing system of claim 13, wherein the first router is further configured to:
receive a second packet from the second router, the second packet including the first IP address as a second destination IP address and a third port number as a third destination port number;
determine that the third port number satisfies the first port criterion; and
based on determining that the third port number satisfies the first port criterion, forward the second packet to the first host device.

20. The routing system of claim 13, wherein the first source port number satisfies the first port criterion when the first source port number is an odd number, and the first source port number fails to satisfy the first port criterion when the first source port number is an even number.
